(19) United States
(12) Patent Application Publication
(10) Pub. No.: US 2002/0122955 A1
(43) Pub. Date: Sep. 5, 2002

(54) Interior flash formation and shielding method for friction/interia welding

(76) Inventor: Bennett J. McCabe, Valencia, CA (US)

Correspondence Address: Bennett J. McCabe, 28059 Avenue Stanford, Valencia, CA, 91355, US

(21) Appl. No.: 09/897,210

(22) Filed: Jul. 2, 2001

Related U.S. Application Data
(60) Provisional application No. 60/216,137, filed on Jul. 3, 2000.

(51) Int. Cl. B23K 20/12; B22D 7/00; B22D 9/00; H01F 1/16

(52) U.S. Cl. 428/544; 228/112.1

(57) ABSTRACT

An apparatus and method for producing a fatigue resistant friction/inertia welded joint in a part with hollow cylindrical cavity(s). Hollow cylindrical sleeve(s) are press fit into the cavity(s) prior to the application of the conventional steps of friction/inertia welding. The joint created is fatigue resistant due to the sequence of flash flowing into the hollow portion of the inserted sleeve, deflecting the end of the inserted sleeve inward, forming a radius and eliminating the possibility of the interior flash bonding to or notching the interior wall(s) of the part. This method eliminates potential stress risers by achieving both ideal flash formation and interior cavity shielding.

### BACKGROUND OF THE INVENTION

A friction/inertia welded part having interior flash which is formed and shielded to eliminate potential stress risers (sharp flash corners, notching, and other crack initiation sites) is disclosed, along with a method for producing such parts. The friction/inertia welded parts are comprised firstly of a piece with a hollow cylindrical cavity, and secondly of an additional piece with or without a hollow cylindrical cavity, to which the first piece is friction/inertia welded. Hollow cylindrical sleeve(s) are press fit into the cavity(s) prior to the application of the conventional steps of friction/inertia welding. During the welding process, the interior flash flows into the hollow portion of the inserted sleeve, deflecting the end of the inserted sleeve inward, forming a radius and eliminating the possibility of the interior flash bonding to or notching the interior wall(s) of the piece(s) with hollow cylindrical cavity(s).

Although originally designed and utilized to produce fatigue resistant friction/inertia welded joints in hollow stem valves for internal combustion engines, this method can be utilized for high strength friction/inertia welded joints in any other critical stress components containing hollow cylindrical cavity(s). The method is particularly useful when friction/inertia welding tube or pipe with small interior diameters which usually result in the formation of shat stress prone corners under the interior flash rolls (when this method is not utilized) due to the restriction of interior flash flow.

### BRIEF DESCRIPTION OF THE DRAWINGS

FIG. 1: typical example of pieces required to produce a high strength friction/inertia welded joint between a tube and a solid or a tube and a tube.

FIG. 2: cross sectional view of small diameter friction/inertia welded samples depicting various flash formations and shielding.

FIG. 3: cross sectional view of large diameter friction/inertia welded samples depicting various flash formations and shielding.

FIG. 4: cut away view of a friction/inertia welded joint between a tube and a solid, where one possible example of the inserted sleeve and interior flash formation is visible.

FIG. 5: cut away view of a friction/inertia welded joint between a tube and a tube, where one possible example of the inserted sleeves and interior flash formations are visible.

### DESCRIPTION OF THE DRAWINGS

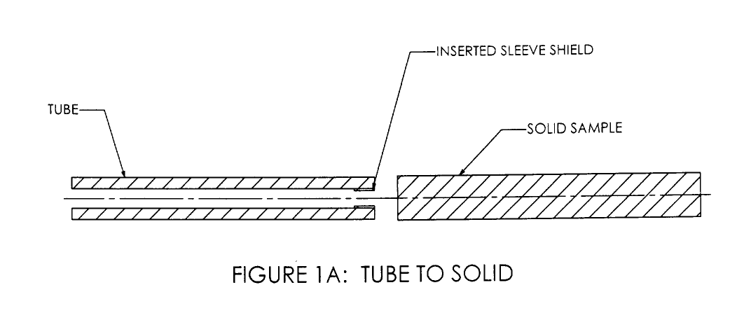

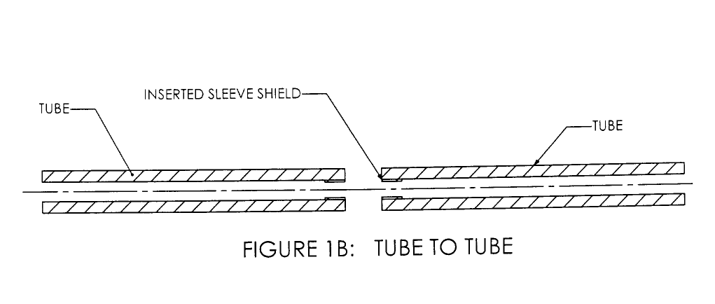

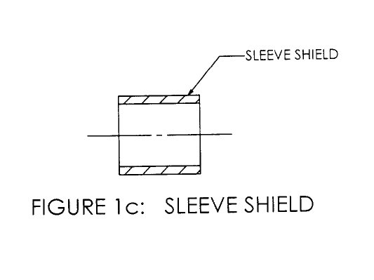

FIG. 1A: typical example of pieces required to produce a high strength friction/inertia welded joint between a tube and solid.

FIG. 1B: typical example of pieces required to produce a high strength friction/intertia welded joint between a tube and a tube.

FIG. 1C: typical example of a “sleeve shield” prior to being press fit into the end of a tube.

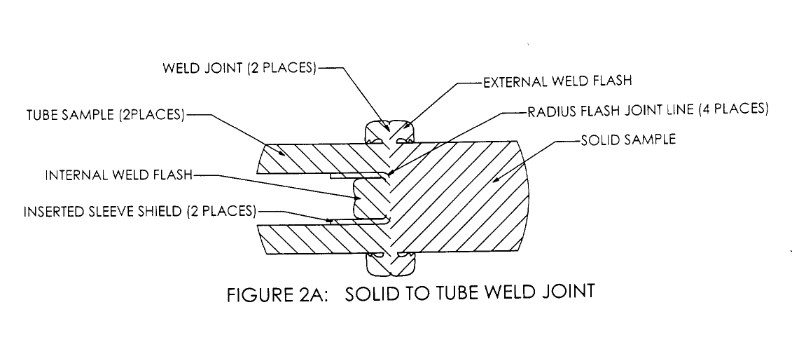

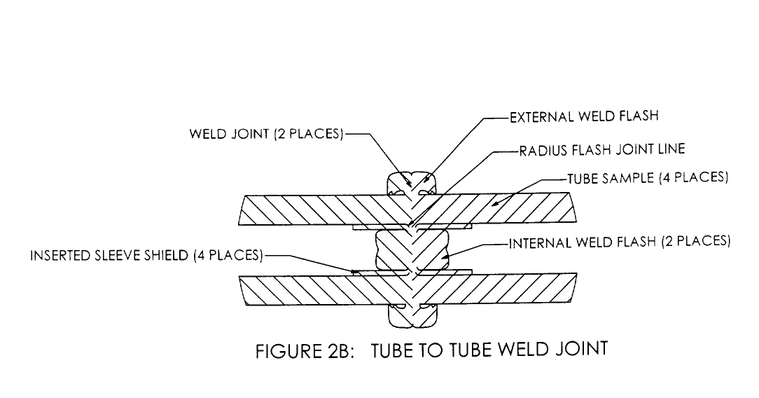

FIG. 2A: cross sectional view of small diameter tube friction/inertia welded to a solid rod depicting various flash formations and shielding.

FIG. 2B: cross sectional view of small diameter tube friction/inertia welded to another tube depicting various flash formations and shielding.

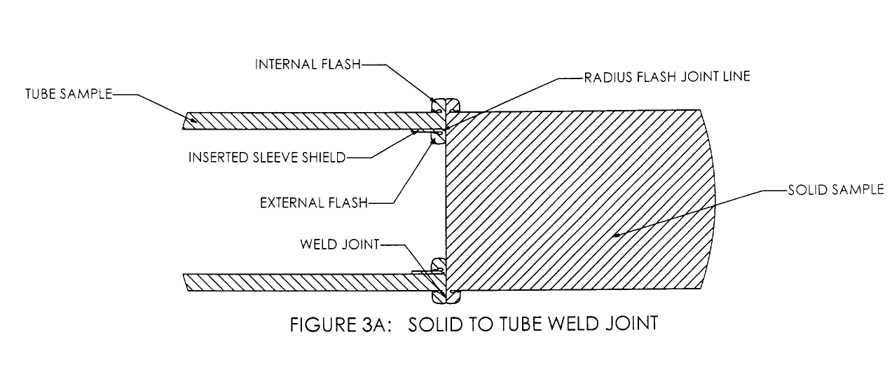

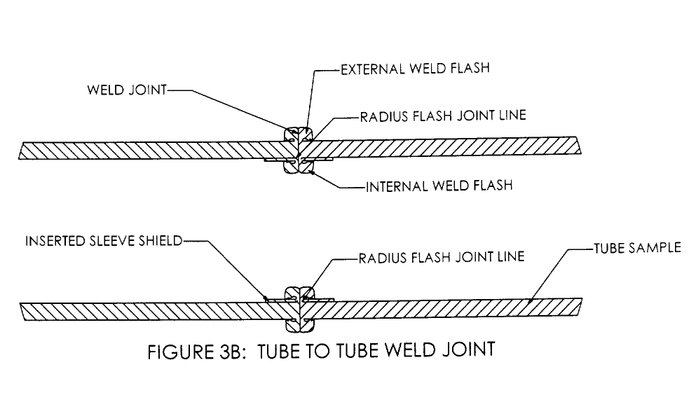

FIG. 3A: cross sectional view of large diameter tube friction/inertia welded to a solid rod depicting various flash formation and shielding.

FIG. 3B: cross sectional view of large diameter tube friction/inertia welded to another tube depicting various flash formation and shielding.

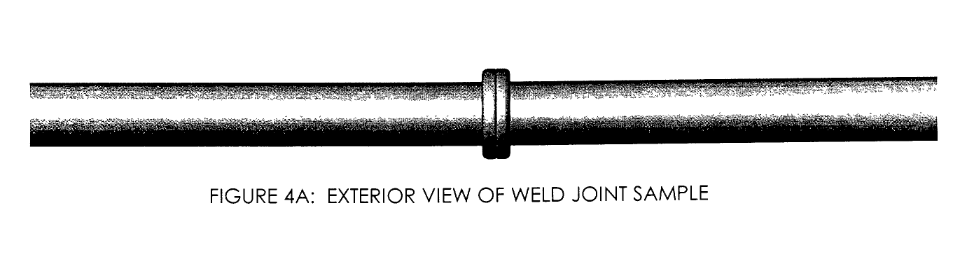

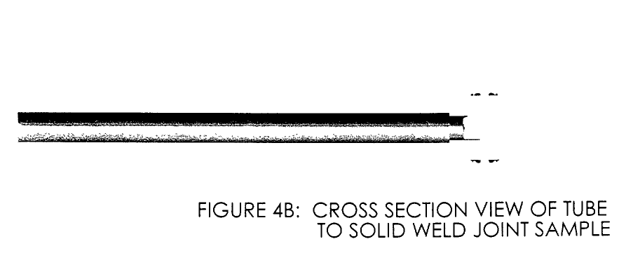

FIG. 4A: typical exterior view of a friction/inertia welded joint between a solid rod and a tube.

FIG. 4B: cut away view of a friction/inertia welded joint between a tube and a solid, where one possible example of the inserted sleeve and interior flash formation is visible.

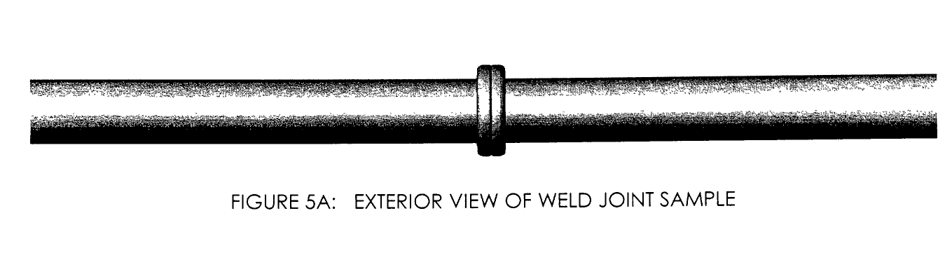

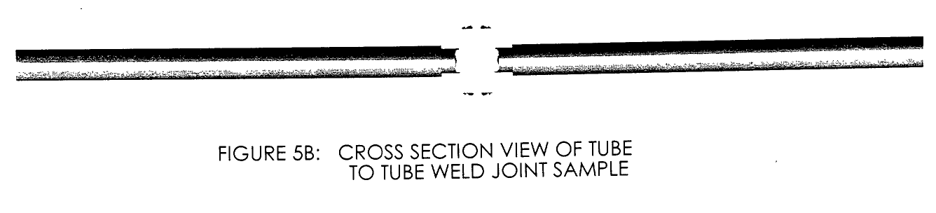

FIG. 5A: typical exterior view of a friction/inertia welded joint between a tube and another tube.

FIG. 5B: cut away view of a friction/inertia welded joint between a tube and a tube, where one possible example of the inserted sleeves and interior flash formations are visible.

What is claimed is:

1. in a friction/inertia welded part comprising firstly of a piece with a hollow cylindrical cavity and secondly of an additional piece with or without a hollow cylindrical cavity to which said first piece with a hollow cylindrical cavity is friction/inertia welded, said friction/inertia welded part including a friction/inertia weld between said first piece with a hollow cylindrical cavity and said second piece, and an internal flash sleeve(s) inserted into the hollow cylindrical cavity(s) in the region of the weld, the improvement in which the interior flash from the friction/inertia weld forms a radius as it flows into the inserted sleeve and is shielded from contact with the interior wall(s) of the hollow cylindrical cavity(s).

2. A friction/inertia welded part as recited in claim 1, in which said sleeve(s) is (are) defined by a hollow cylinder of a diameter greater than the inner diameter of said piece(s) with a hollow cylindrical cavity. Prior to any formation of flash from said friction/inertia weld joint, an individual hollow cylindrical sleeve is pressed into each individual piece with a hollow cylindrical cavity with enough interference of the fit to resist any relative rotation or movement between the said sleeve and the piece with the hollow cylindrical cavity into which the said sleeve has been inserted to a flush or near flush position with the plane of the surface to be friction/inertia welded. Said hollow cylindrical sleeve(s) having a melting point similar to or identical to the said piece(s) with the hollow cylindrical cavity(s).

3. A friction/inertia welded part as recited in claim 1, in which the common sharp corners formed. under the flash rolls are eliminated and replaced with corners formed as radiuses as the interior flash flows into the hollow portion of the said inserted sleeve deflecting the end of each said inserted sleeve inward, resulting in elimination of potential crack initiation sites.

4. A. friction/inertia welded part as recited in claim 1, in which the said inserted sleeve(s) serve as a protective shield to eliminate the possibility of interior flash bonding to or notching the interior wall(s) of the said piece(s) with hollow cylindrical cavity(s).

5. A friction/inertia welded part as recited in claim 1, in which the said inserted sleeve(s) form unbonded joint lines with the said piece(s) containing hollow cylindrical cavity(s), and weakly or unbonded joint lines with the interior flash, resulting in joint lines which serve as termination planes or points for any stress cracks propagating within the interior weld flash.

6. A friction/inertia welded part as recited in claim 1, in which said internal flash may or may not completely fill the said inserted sleeve, and will be dependant upon the friction/inertia weld parameters utilized, the inside diameter of the said inserted sleeve, and the exterior size of both the said first piece with a hollow cylindrical cavity and the said second piece with or without a hollow cylindrical cavity.

7. A friction/inertia welded part as recited in claim 1, in which the said first piece with a hollow cylindrical cavity and the said second piece with or without a hollow cylindrical cavity consist of any possible external shape or profile and any possible material or variety of materials which can be friction! inertia welded including, but not limited to, tube to plate, pipe to plate, pipe to bar, tube to bar, tube to tube, and pipe to pipe.
